(19) United States
(12) Patent Application Publication
(10) Pub. No.: US 2024/0340487 A1
(43) Pub. Date: Oct. 10, 2024

(54) SYSTEM AND METHOD FOR CONFIGURING A CONTENT SELECTION INTERFACE

(71) Applicant: ThinkAnalytics Ltd., Glasgow (GB)

(72) Inventors: Asim Ullah, Glasgow (GB); Bryan Bossard, Canyon Country, CA (US); Ewen Cattanach, Glasgow (GB); Peter Docherty, Glasgow (GB); Christopher McGuire, Glasgow (GB)

(73) Assignee: ThinkAnalytics Ltd., Glasgow (GB)

(21) Appl. No.: 18/130,891

(22) Filed: Apr. 4, 2023

(51) Int. Cl. H04N 21/431; G06F 3/0482; G06F 3/0485

(52) U.S. Cl. CPC H04N 21/4312; G06F 3/0482; G06F 3/0485

(57) ABSTRACT

A computer-implemented method of configuring a content selection interface and associated system, the method comprising: identifying groups of content; obtaining user activity, wherein the user activity comprises interactions by the user with groups of content on a content selection interface; and ordering groups of content for presentation to the user on the content selection interface based at least in part on the user activity of that user.

### FIELD

The present disclosure relates to a system and method for use in configuring content selection interfaces, such as but not limited to electronic program guides. In examples, the content selection interfaces can be configured for specific users.

### BACKGROUND

Developments in technology mean that users are able to access content via a wide array of different mechanisms, and via a wide array of different sources. For example, television channels, radio stations, video-on-demand and other streaming services, social media and other internet content sources provide a vast array of content available to a user.

By providing a large volume of content, content distribution platforms can cater to a large range of different user preferences and provide content previously unseen to a user to hold the user's interest. However, the large volumes of available content gives rise to challenges in making it easy for users to identify, navigate and select content. These challenges may be exacerbated by technical limitations such as limited screen estate for providing electronic program guides.

Electronic program guides and other content selection interfaces can be structured to improve navigation. For example, one arrangement is to provide a content selection interface having multiple “carousels”, each carousel comprising multiple content items. The carousels can be themed, with the content in each carousel being selected according to the theme for the carousel. Examples of themes include different genre types such as “action”, “romance”, “sci-fi”, and the like. Other examples of themes could include popularity based themes such as “most watched”. Sometime, carousels need not be themed and a plurality of content items can simply be grouped together. A user can scroll up or down through carousels, and side to side through the content items in any carousel in order to identify a content item for selection.

However, it may be beneficial to make it easier for a user to identify and select content of interest using electronic program guides and other content selection interfaces.

### SUMMARY

Content selection interfaces can allow users to conveniently identify and select content for consumption. However, there are technical challenges posed by the likes of the sheer volume of content available and the limitations on on-screen area of many user devices for presenting the content selection interface. Furthermore, being able to access and use the content selection interface with as little lag as possible, may make overly large, complex or inefficient processes for providing the content selection interface undesirable. Given the vast numbers of users and requests, ultra-fast response times in the order of milliseconds are highly desirable. As such, improvements in content selection interface in order to enhance the ability of a user to search for content stored by, and available from, a service provider's computer systems whilst keeping lag acceptably small may be beneficial.

Tracking, recording and processing large volumes of customer data together with large amounts of content data within reasonable time constraints and with acceptable accuracy poses a significant technical challenge. The time constraints demanded by particular content providers, or expected by users, may be particularly demanding This can present a significant technical challenge, particularly as the system is usually hosted on one or more servers remote from the set top box or other device and, for systems with millions of subscribers, may have to deal simultaneously with millions of user actions or interactions per minute during busy periods.

The following are provided as examples of the present disclosure.

According to a first example of the present disclosure is a computer-implemented method of configuring a content selection interface, the method comprising: identifying groups of content; obtaining user activity, wherein the user activity comprises interactions by the user with groups of content on a content selection interface; and ordering groups of content for presentation to the user on the content selection interface based at least in part on the user activity of that user.

The content selection interface may be configured to allow user selection of the presented content for viewing, e.g. on a user device, such as a user device on which the content selection interface is provided. The content selection interface may be configured to display indications of at least some of the content in groups of content, wherein the indications of content may be selectable in order to provide the selected content, e.g. to selectively download, stream and/or playback the selected content, which may be on a user device, such as a user device on which the content selection interface is provided.

The content selection interface may comprise a plurality of scrollable carousels. Each carousel may display an associated group of content. The method may comprise providing indications of the content of the associated group of content to the user in respective carousels of the user interface. The ordering of the groups of content may comprise ordering the carousels in the user interface. The user interface may be configured to allow scrolling through different carousels. The user interface may be configured to allow scrolling through content within individual carousels. The ordering of the carousels may be based at least in part on the user activity.

The method may comprise monitoring user interactions with groups of content on a user interface. The user activity may comprise one or more user actions. The user interaction with groups of content on the user interface may comprise one or more of: selecting content from a group of content or a related group of content; scrolling through content in a group of content or a related group of content; hovering a cursor for greater than a threshold period over a group of content or a related group of content; pausing scrolling for greater than a threshold period through groups of content whilst a group of content or a related group of content is displayed on a user interface; downloading content that is in a group of content or related group of content; watching at least part of content that is in a group of content or related group of content; bookmarking content that is in a group of content or related group of content; browsing content that is in a group of content or related group of content; recording content that is in a group of content or related group of content; adding content that is in a group of content or related group of content to a virtual shopping basket or otherwise selecting the content for purchase or potential purchase; watching or listening to a trailer for content that is in a group of content or related group of content; playing content that is in a group of content or related group of content on a user device; purchasing content that is in a group of content or related group of content; clicking on or otherwise selecting content that is in a group of content or related group of content from a list of search results; remotely recording content that is in a group of content or related group of content; setting a reminder for content that is in a group of content or related group of content; liking, making a favorite or otherwise adding to a list content that is in a group of content or related group of content; disliking content that is in a group of content or related group of content; messaging about content that is in a group of content or related group of content; posting on social media about content that is in a group of content or related group of content; playing purchased content that is in a group of content or related group of content; stopping watching or playing content that is in a group of content or related group of content; rating content that is in a group of content or related group of content; and/or the like.

The related group of content may be a group of content having the same or a related theme or comprising at least one content item in common.

The ordering of the groups of content for presentation to the user on the user interface may comprise ranking the groups in order of expected preference of the user. The ordering of the groups of content for presentation to the user on the user interface may comprise applying a machine learning model to the user activity. The machine learning model may be trained or otherwise configured to output the expected preference of the user based on the user activity. The machine learning model may be configured to receive feedback from the user regarding the quality of the ordering of the groups of content by the machine learning model and may update the machine learning model based on the feedback, and optionally also the user actions, and further optionally also the context or other data, on which that ordering of the groups of content was based.

The ordering of the groups of content for presentation to the user on the user interface for a user may comprise ordering for display at least one or some groups of content for which there have been a higher number of interactions by that user preferentially to at least one or some other groups of content for which there have been a lower number of interactions by that user. The ordering of the groups of content for presentation to the user on the user interface for a user may comprise assigning a ranking score to each of the groups of content, wherein the ranking score depends at least on part on the number of interactions by that user with content in the group of content on a content selection interface. The ranking score may depend at least in part on context data. The context data may comprise or be reflective of variable influences on user content selections. The context data may comprise one or more of: weather data, time of day data, date data, season data, current affairs data, trending topic data, a list of preferential themes or topics, and/or the like. The machine learning model may have the context data as inputs in addition to the user activity.

The method may comprise presenting, e.g. automatically presenting, the groups of content to the user on the user interface in the determined order based at least in part on the user activity. The method may comprise providing an indication of the ordered groups of content on an interface for generating content selection interfaces.

The method may comprise fixing a place of one or more groups of content in an ordering of groups of content in the content selection interface and placing at least one or each other of the groups of content in the content selection interface based at least in part on the user activity. The method may be implemented as part of a content selection interface configuration tool. The method may comprise selecting, using the user interface configuration tool, the one or more groups of content whose place in the ordering of groups of content is to be fixed. The method may comprise selecting, using the user interface configuration tool, the at least one or each other of the groups of content that are to be placed in the ordering of groups of content based at least in part on the user activity. The groups of content may be arranged or arrangeable into folders, wherein each folder comprises a plurality of groups of content. The method may comprise selecting, using the content selection interface configuration tool, folders to be fixed. A folder may comprise a plurality of groups of content. Fixing a folder may fix the places of all of the plurality of groups of content in that folder in the ordering of groups, e.g. so that placing content of the groups of content of that folder is fixed and not based at least in part on the user activity. The method may comprise selecting, using the user interface configuration tool, folders that are personalizable. The places of all of the plurality of groups of content in a personalizable folder may be placed or are placable in the ordering of groups of content based at least in part on the user activity.

The content selection interface may be a content selection interface of an electronic program guide, EPG. The method may be performed in conjunction with a method of providing television content or other content to each of a plurality of users using a content distribution system. The content selection interface may be a content selection interface of a different type of content provision system, such as an article selection system, a music selection system, a video game selection system, a film selection system, a written content selection system, an image selection system, and/or the like. A user device of each user may display the content selection interface. The content selection interface may be operable by the user of the user device to select one or more items of television or other content. A content distribution system may be configured to, in response to the selection, distribute the selected items of television content or other content to the user devices for viewing by the users during content viewing sessions.

The ordering of the groups of content for presentation to the user on the user interface may comprise determining a personalized ordering the groups of content for presentation to that user on the content selection interface of a user device of that user based at least in part on the user activity of that user. The ordering of the groups of content may be personalized for a specific user or group of users based at least in part on the user activity of that specific user or group of users.

The ordering of the groups of content for presentation to the user on the user interface may be based on data of a content distribution system or middleware operator and may not comprise 3rd party data. The method may be performed by a middleware system that sits between the users and a content provider system. The method may be performed by a content provider system.

At least one or each group of content may be a group in which content in the group is related by a common theme. At least one or each group of content may be a group of content selected by a user, i.e. a user may select the content that is contained in a group of content. At least one or each group of content may be a group of content selected by a recommendation system for a user, e.g. based on prior user activity.

The ordering of the groups of content for presentation to the user on the content selection interface may be based at least in part on the user activity of that user and other data, such as the context data. For example, the method may comprise providing mapping data mapping the context data to groups of content or themes of groups of content for preferential ordering.

Method steps of the invention can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customized circuitry. Processors suitable for the execution of a computer program include central processing units (CPUs), graphics processing units (GPUs), Tensor Processing Units (TPUs), maths-co-processors and microprocessors, and any one or more processors. The processors may be single core or multi-core. Generally, a processor will receive instructions and data from a read-only memory or a random access memory or both. The essential elements of a computer are a processor for executing instructions and one or more memory devices for storing instructions and data. The processor may be provided as part of a cloud computing resource, which is network connected and may comprise one or more computer systems, such as servers, and one or more data storage devices. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

According to a second example of the present disclosure is a system comprising processing circuitry configured to: obtain user activity, the user activity comprising user interactions with a content user selection interface on a user device; identify groups of content, each group of content having a theme; and order groups of content for presentation to a user on the user interface based at least in part on the user activity of that user.

The system may comprise middleware or a computer system configured to provide services to a provider of a user content selection interface. The user content selection interface may be provided by a computer system of the provider or on behalf of the provider. The provider may be the provider of content, such as but not limited to a television channel. The middleware or intervening computer system may be a cloud based system. The middleware or intervening computer system may be a network connected computer system and may be configured to communicate with one or both of: the computer system of the provider and/or the user devices over the network. In other examples, the system is comprised in a computer system of a provider, i.e. of a content provider. The system may be a distributed computer system or may be a unitary computer system.

The content selection interface may be configured to allow user selection of the presented content for viewing, e.g. on a user device, such as a user device on which the content selection interface is provided. The content selection interface may be configured to display indications of at least some of the content in groups of content, wherein the indications of content may be selectable in order to select download and/or playback of the selected content, e.g. on a user device, such as a user device on which the content selection interface is provided. The content selection interface may be provided on a display of the user device, such as a touch screen display.

The content selection interface may comprise a plurality of scrollable carousels. The method may comprise providing indications of the content in respective groups of content to the user in respective carousels of the user interface. The ordering of the groups of content may comprise ordering the carousels in the user interface. The user interface may be configured to allow scrolling through different carousels. The user interface may be configured to allow scrolling through content within individual carousels. The ordering of the carousels may be based at least in part on the user activity.

The system may be configured to monitor user interactions with groups of content on a user interface in order to obtain the user activity. The user interaction with groups of content on the user interface may comprise one or more of: selecting content from a group of content or a related group of content; scrolling through content in a group of content or a related group of content; hovering a cursor for greater than a threshold period over a group of content or a related group of content; pausing scrolling for greater than a threshold period through groups of content whilst a group of content or a related group of content is displayed on a user interface; downloading content that is in a group of content or related group of content; watching at least part of content that is in a group of content or related group of content; bookmarking content that is in a group of content or related group of content; browsing content that is in a group of content or related group of content; recording content that is in a group of content or related group of content; adding content that is in a group of content or related group of content to virtual shopping basket or otherwise selecting for purchase or potential purchase; watching or listening to a trailer for content that is in a group of content or related group of content; playing content that is in a group of content or related group of content on a user device; purchasing content that is in a group of content or related group of content; clicking on or otherwise selecting content that is in a group of content or related group of content from a list of search results; remotely recording content that is in a group of content or related group of content; setting a reminder for content that is in a group of content or related group of content; liking, making a favorite or otherwise adding to a list content that is in a group of content or related group of content; disliking content that is in a group of content or related group of content; messaging about content that is in a group of content or related group of content; posting on social media about content that is in a group of content or related group of content; playing purchased content that is in a group of content or related group of content; stopping watching or playing content that is in a group of content or related group of content; rating content that is in a group of content or related group of content; and/or the like. For example, the system may be configured to receive user action directly from the user device or indirectly from the user device, e.g. via one or more intermediary computer systems, such as those of the provider.

The related group of content may be a group of content having the same or a related theme or comprising at least one content item in common.

The ordering of the groups of content for presentation to the user on the user interface may comprise ranking the groups in order of expected preference of the user. The system may comprise a machine learning module configured to implement a machine learning model that receives the user activity as input. The machine learning model may be configured to output the expected preference of the user based at least in part on the user activity.

The ordering groups of content for presentation to the user on the user interface for a user may comprise ordering for display at least one or some groups of content for which there have been a higher number of interactions by that user preferentially to at least one or some other groups of content for which there have been a lower number of interactions by that user.

The system may be configured to provide computer readable data and/or instructions for presenting the groups of content to the user on the user interface in the determined order based at least in part on the user activity. The system may be configured to provide computer readable data and/or instructions for providing an indication of the ordered groups of content on an interface for generating content selection interfaces.

The system may be configured to implement fixing of a place of one or more groups of content in an ordering of groups of content in the content selection interface and placing at least one or each other of the groups of content in the content selection interface based at least in part on the user activity. The system may be configured to implement a content selection interface configuration tool. The user interface configuration tool may be configured to receive selection of the one or more groups of content whose place in the ordering of groups of content is to be fixed. The user interface configuration tool may be configured to receive selection of the at least one or each other of the groups of content that are to be placed in the ordering of groups of content based at least in part on the user activity. The groups of content may be arranged or arrangeable into folders, wherein each folder comprises a plurality of groups of content. The user interface configuration tool may be configured to receive selection of folders to be fixed. Fixing a folder may fix the places of all of the plurality of groups of content in that folder in the ordering of groups, e.g. so that placing content of the groups of content of that folder is fixed and not based at least in part on the user activity. The user interface configuration tool may be configured to receive selection of folders that are personalizable. The places of all of the plurality of groups of content in a personalizable folder may be placed or are placable in the ordering of groups of content based at least in part on the user activity.

The content selection interface may be a content selection interface of an electronic program guide, EPG. The method may be performed in conjunction with a method of providing television content or other content to each of a plurality of users using a content distribution system. The content selection interface may be a content selection interface of a different type of content provision system, such as an article selection system, a music selection system, a video game selection system, a film selection system, and/or the like. A user device of each user may display the content selection interface. The content selection interface may be operable by the user of the user device to select one or more items of television or other content. A content distribution system may be configured to, in response to the selection, distribute the selected items of television content or other content to the user devices for viewing by the users during content viewing sessions.

The ordering of the groups of content for presentation to the user on the user interface may comprise determining a personalized ordering the groups of content for presentation to that user on the content selection interface of a user device of that user based at least in part on the user activity of that user. The ordering of the groups of content may be personalized for a specific user or group of users based at least in part on the user activity of that specific user or group of users.

The ordering of the groups of content for presentation to the user on the user interface may be based on data of a content distribution system or middleware operator and may not comprise 3rd party data.

At least one or each group of content may be a group in which content in the group is related by a common theme. At least one or each group of content may be a group of content selected by a user, i.e. a user may select the content that is contained in a group of content.

The ordering groups of content for presentation to the user on the content selection interface may be based at least in part on the user activity of that user and other data, such as context data. The context data may be or comprise weather data, news feed, trending items lists, list of preferential themes or topics, and/or the like. For example, the method may comprise providing mapping data mapping context data to groups of content or themes of groups of content for preferential ordering.

The system may be configured to implement at least part or all of the method of the first example. The system may comprise a device, such as a cloud computing resource or other network enabled device, comprising or configured to implement the system of the second example. The controller or processing system may be implemented by a suitable program or application running on the device. The device may comprise at least one processor, such as a central processing unit (CPU), maths co-processor (MCP), graphics processing unit (GPU), tensor processing unit (TPU) and/or the like. The at least one processor may be a single core or multicore processor. The device may comprise memory and/or other data storage, which may be implemented on DRAM (dynamic random access memory), SSD (solid state drive), HDD (hard disk drive) or other suitable magnetic, optical and/or electronic memory device. The at least one processor and/or the memory and/or data storage may be arranged locally, e.g. provided in a single device or in multiple devices in in communication at a single location or may be distributed over several local and/or remote devices. The device may comprise a communications module, e.g. a wireless and/or wired communications module. The communications module may be configured to communicate over a cellular communications network, Wi-Fi, Bluetooth, ZigBee, near field communications (NFC), IR, satellite communications, other internet enabling networks and/or the like. The communications module may be configured to communicate via Ethernet or other wired network or connections, via a telecommunications network such as a POTS, PSTN, DSL, ADSL, optical carrier line, and/or ISDN link or network and/or the like, via the cloud and/or via the internet, or other suitable data carrying network. The communications module may be configured to communicate via optical communications such as optical wireless communications (OWC), optical free space communications or Li-Fi or via optical fibers and/or the like. The device and/or the controller or the at least one processor or processing unit may be configured to communicate with the remote server or data store via the communications module. The controller or processing unit may comprise or be implemented using the at least one processor, the memory and/or other data storage and/or the communications module of the device.

According to a third example of the present disclosure is a non-transitory computer-readable medium that comprises computer-readable instructions that are executable to configure a content selection interface, the configuration comprising: identifying groups of content; obtaining user activity, wherein the user activity comprises interactions by the user with groups of content on a content selection interface; and ordering groups of content for presentation to the user on the content selection interface based at least in part on the user activity of that user. The computer-readable instructions may implement the method of the first aspect. The computer-readable instructions may be implemented by the system of the second aspect.

The individual features and/or combinations of features defined above in accordance with any aspect of the present invention or below in relation to any specific embodiment of the invention may be utilized, either separately and individually, alone or in combination with any other defined feature, in any other aspect or embodiment of the invention.

Furthermore, the present invention is intended to cover apparatus configured to perform any feature described herein in relation to a method and/or a method of using or producing, using or manufacturing any apparatus feature described herein.

### BRIEF DESCRIPTION OF THE DRAWINGS

Various examples of the present disclosure will now be described by way of example, and with reference to the accompanying drawings, of which:

FIG. 1 is a schematic diagram of a computer system configured to provide services to a provider of a user content selection interface;

FIG. 2 is a simplified schematic of the system of FIG. 1;

FIG. 3 is a simplified schematic of an alternative system arrangement to that of FIG. 2;

FIG. 4 is a schematic of a system for configuring a content selection interface;

FIG. 5 is a schematic of a data structure for a content selection interface;

FIG. 6 is a schematic of a content selection interface;

FIG. 7 is schematic of a group of content displayed on the content selection interface of FIG. 6;

FIG. 8 is a process flow for operating a UX engine of the system of FIG. 1;

FIG. 9 is a process flow for ordering content for display in a content selection interface of the system of FIG. 1;

FIG. 10 is method of providing services to a provider of a user content selection interface; and

FIG. 11 is an example of a user activity record.

### DETAILED DESCRIPTION OF THE DRAWINGS

In TV systems, or other systems for provision of content to a user, each service provider may have thousands, tens or hundreds of thousands, or millions of customers, wherein each customer is unique and may have different viewing habits and preferences. Furthermore, in order to accommodate the range of tastes and interests of such a large customer base, and to keep those customer's interest, the service provider will often provide an extensive range of different content. However, the sheer volume of content available from service provider systems can present difficulties in navigating, identifying and retrieving content that the user would like to access and view. The content available to a user can be stored in a content database of a service provider, but if a user cannot readily navigate the content database to identify content of interest, then the user may get frustrated or may not fully realize the beneficial content available to them. As such, systems for allowing users to better navigate and select the content available from a content provider would be beneficial.

Content selection interfaces, such as but not limited to electronic program guides (EPGs), are generally made available for users to navigate the content available from one or more service providers. Such content selection interfaces can come in a range of forms, but one example of a content selection interface is a carousel based interface in which a number of carrousels are provided in the interface, each carrousel representing a group of content and containing selectable indications of each of the items of content of that group of content. The indications of the items of content are selectable by a user to access the selected content, e.g. to download, stream and/or view the selected content. Each group of content represented by the carousel may contain content linked by a theme or be otherwise grouped, e.g. by manual selection or the like. A user can scroll through the different carousels, for example by scrolling up and down through the carousels. The user can also scroll through the content in any given carousel, such as but not limited to scrolling horizontally through the different items of content in a given carousel, until they find the content that they want. It will be appreciated that the disclosure is not limited to this specific carousel arrangement. For example, the user may be able to scroll through the groups of content in one direction and scroll through the indications of content in a given group in a different direction, which may or may not be horizontal and vertical. In another example, the groups of content can be hierarchical, where a user can drill down through collections of groups of content to select a specific group of content and then select the desired item of content in that group. However, other interface arrangements are possible.

Content selection interfaces such as this have been found to be particularly helpful to viewers. However, there are technical challenges posed by the likes of the sheer volume of content available and the limitations on on-screen area of many user devices for presenting the content selection interface. Furthermore, being able to access and use the content selection interface with as little lag as possible, may make overly large, complex or inefficient processes for providing the content selection interface undesirable. As such, improvements in content selection interface in order to enhance the ability of a user to search for content stored by, and available from, a service provider's computer systems may be beneficial.

Tracking, recording and processing large volumes of customer data together with large amounts of content data within reasonable time constraints and with acceptable accuracy poses a significant technical challenge. The time constraints demanded by particular content providers, or expected by users, may be particularly demanding This can present a significant technical challenge, particularly as the system is usually hosted on one or more servers remote from the set top box or other device and, for systems with millions of subscribers, may have to deal simultaneously with millions of user actions or interactions per minute during busy periods.

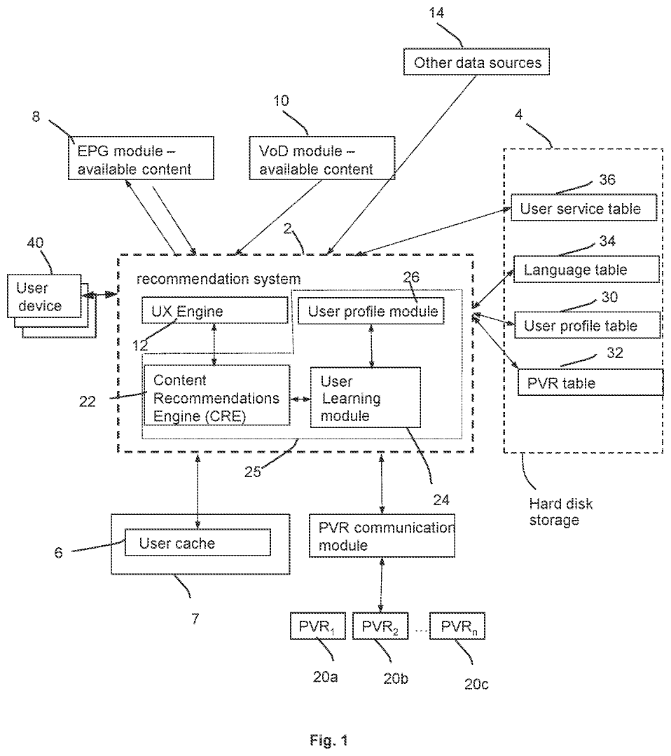

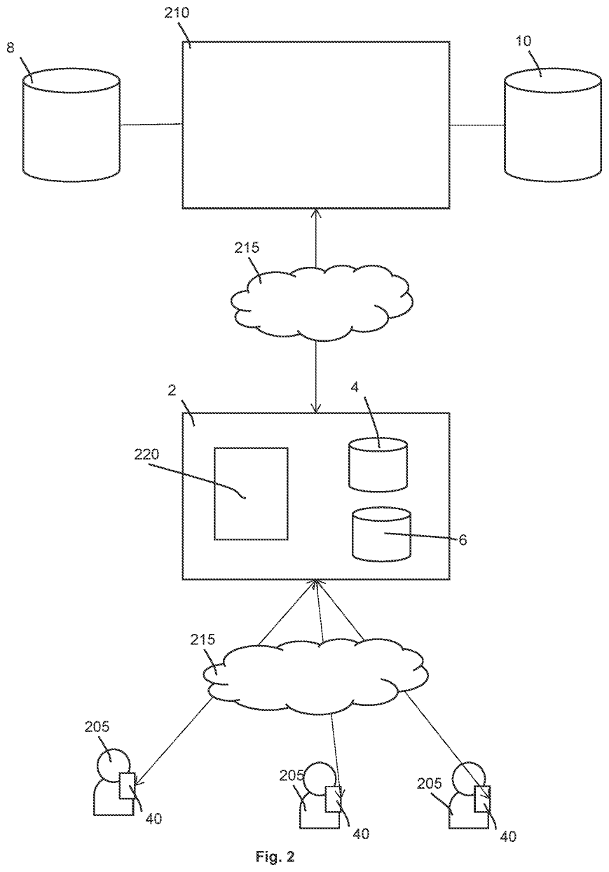

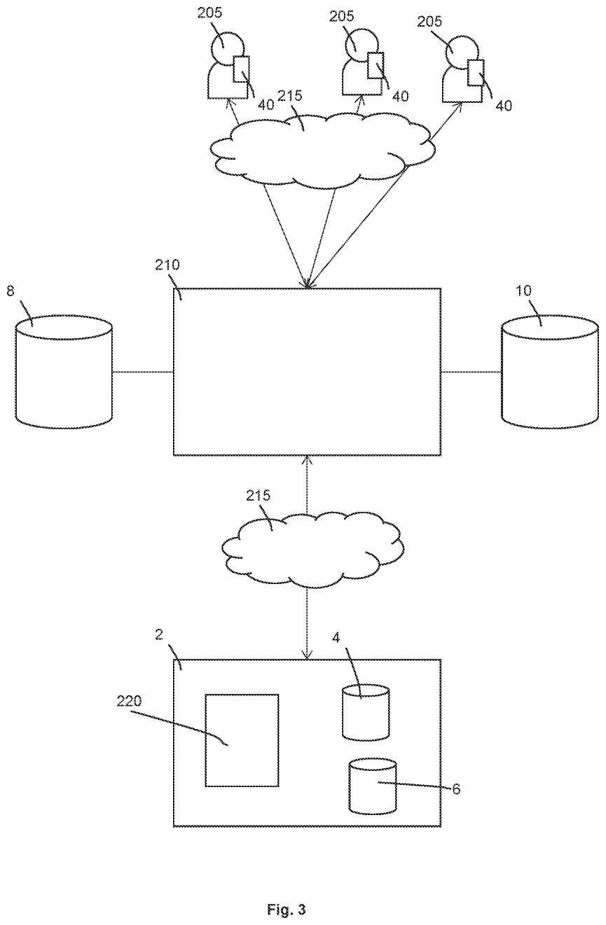

FIG. 1 shows a schematic diagram of a system 1 that comprises a user experience (UX) engine 12 for configuring user content selection interfaces that allow users 205 (see FIGS. 2 and 3) to navigate and select content from a content service provider (210, also shown in FIGS. 2 and 3). In particular, the user experience (UX) engine 12 can be used to provide customized user content selection interfaces that are customized or otherwise specifically configured to a specific user 205 or group of users 205. The customization comprises customizing the order in which groups of content is presented to a user 205 or groups of users 205 so that groups of content more likely to be of interest to the user 205 are presented earlier, or in preference to groups of content that are less likely to be of interest to that user 205.

In the example of FIG. 1, the user experience (UX) engine 12 is provided as part of a more general recommendation system 2 that comprises a content recommendation engine (CRE) 22 that can apply a set of processes to determine, in real time, content recommendations for a user 205 based on user data and available content. This arrangement can be beneficial as there may be some cross-over in the data utilized such that the UX engine 12 can in some examples share or otherwise leverage data used by the CRE 22, which can minimize data storage and other services required to operate both systems. However, the disclosure is not limited to this arrangement and in other examples the UX engine 12 can be provided as a dedicated stand-alone system or as part of a content provider's user interface system or in another suitable component of a content provision system or associated support system.

The content recommendation engine (CRE) 22 in this example is provided as part of an affinity profile generation system, which is operable to generate affinity profiles for users 205 based on first party data in the form of, for example, user actions performed in relation to their selection, viewing and other actions in relation to TV content provided by a TV distribution system, and/or in relation to other content. The recommendation system 2 in the embodiment of FIG. 1 is also able to provide content recommendations to users as well as generating affinity profiles. Content recommendations may be provided in real time or near real time for tens of thousands, hundreds of thousands, or even millions of users. However, as noted above, this is an optional arrangement, and the UX engine 12 need not be provided as part of such a recommendation system 2 and can be provided as a stand-alone system or as part of a system with other functionality.

The UX engine 12 is configured to take into account previous interactions that the user 205 has had with user content selection interfaces. These could include interactions the user 205 has had with the user content selection interface that the system 1 is currently looking to configure and/or with other user content selection interfaces. Beneficially, such user interactions may comprise first party data in the form of, for example, user actions performed in relation to their selection, viewing and other actions in relation to content such as but not limited to TV content provided by a TV distribution system or other types of content.

Some example modes of operation are described below in relation to PVRs associated with users, but content may be provided or accessible via any suitable devices, for example set-top boxes, smartphones, PCs or tablets or any other suitable content delivery mechanism.

As noted above, the system 1 in the embodiment of FIG. 1 comprises the recommendation system 2 that includes the content recommendation engine (CRE) 22, the UX engine 12 and a user profile module 26, each of which is linked to a first storage resource in the form of a hard disk storage device 4, which is used to store various user data, including user actions. The recommendation system 2 is also communicatively linked to a second storage resource in the form of a local storage device that includes at least one cache, for example a user cache 6. In the embodiment of FIG. 1 the local storage device is in the form of RAM 7 but any suitable storage device may be used in alternative embodiments. The user cache 6 may be used for temporary storage of user data obtained from the hard disk storage device 4 during a user session.

As discussed further below, recommendation system 2 is able to communicate, either directly or indirectly, and either via wired or wireless connection, with very large numbers of users 205 or user devices 40 and to provide recommendations for or derived from such users 205 or their user devices 40. Other than some PVRs which are shown schematically in FIG. 1, only a few user devices 40 are shown in FIG. 1 for clarity, but it will be appreciated that more or less user devices 40 could be present. The user devices 40 could include, as examples only, a user's mobile phone, smart TV, tablet computer, laptop, smart watch or other suitable viewing device. Although the user devices 40 could belonging to the user 205, they could also comprise any other device that the user 205 is logged into.

The recommendation system 2, and specifically the CRE 22, the UX engine 12 and the user profile module 26 are also linked to sources of information concerning available content, in this case an EPG module 8 and a Video-on-Demand (VoD) module 10 which provide information about content available to a user 205 from a service provider system 210 (see FIGS. 2 and 3) via an EPG (for example, scheduled TV programs on a set of channels) and via a VoD service. In alternative embodiments, a variety of other sources of content may be available as well as, or in addition to, EPG and VoD content, for example internet content and/or any suitable streamed content via wired or wireless connection. The EPG is provided as an example of a content selection interface that allows users 205 to look for content available from the service provider and to select content, e.g. for download, streaming and/or viewing. However, the present disclosure is not limited to EPGs and could also be applied to other content selection interfaces, e.g. for music provision services, audio book services, film streaming services, creator content, book or article selection interfaces, amongst others. The content may comprise video, audio, text, images, or other data.

In the embodiment of FIG. 1, the EPG module 8, the UX engine 12, the user profile module 26, the VoD module 10, the CRE 22, the user cache 6, the PVR communication module 12, and a user learning module 24 are implemented in a server. The server includes communication circuitry that enables communication between the server, or appropriate components of the server, with each of the user devices 40, and with the content sources, for example a TV service operator or other content service operator. However, other arrangements are possible, e.g. one or more of the above components may be distributed over other system or more generally in the cloud.

Any other suitable implementation of the EPG module 8, the VoD module 10, the UX engine 12, the user profile module 26, the content recommendation engine (CRE) 22, the user cache 6, the PVR communication module 12, and the user learning module 24 may be provided in alternative embodiments, for example they may be implemented in any software, hardware or any suitable combination of software and hardware. Furthermore, in alternative embodiments any one of the components described in relation to the embodiment of FIG. 1 or other embodiments may be combined with any other one(s) of the components, or any one of the components may be split into multiple components providing the same or similar functionality.

The EPG module 8 and the VoD module 10 obtain information concerning available content from the content sources, for example a TV service operator or other content service operator. The content information comprises metadata of content, for example, television program metadata. The metadata may be representative of a variety of different content parameters or properties, for example but not limited to program title, time, duration, content type, program categorization, actor names, genre, release date, episode number, series number. It is a feature of the embodiment that the metadata stored at the EPG module 8 and the VoD module 10 may also be enriched with additional metadata, for example by the operator of the system, such that additional metadata to that provided by the content sources or other external sources may be stored.

In the embodiment of FIG. 1 the system 1 operates together with three sources of content for a user device 40: real-time linear television, for example terrestrial or satellite broadcast television; one or more video-on-demand (VoD) services, and pre-recorded video content stored on one or more personal video recorders (PVR). In alternative embodiments further sources of content as well as or instead of those shown may be used.

The operation of the system 1 is controlled by the recommendation system 2. As can be seen in FIG. 1, the recommendation system 2 is configured to communicate with the one or more content information modules such as the electronic program guide (EPG) module and VoD module 10. The recommendation system 2 is also configured to communicate with the user cache 6 local to the recommendation system 2, the hard disk storage resource 4 and the one or more PVRs. A data access layer provides a communication interface between the recommendation system 2 and the hard disk storage resource 4. A personal video recorder (PVR) communication module 12 provides a communication interface between the one or more PVRs 20a, 20b, . . . 20z and the affinity profile and recommendation system 2.

As discussed in more detail below, the user profile module 26 is operable to use first party data obtained by an operator of the system to determine user activity profiles of individual users 205 or sets of users 205, which are representative of actions of a user 205 with respect to content selection interfaces.

The content recommendation engine (CRE) 22 can apply a set of processes to determine, in real time, content recommendations for a user 205 based on user data and available content.

The user learning module 24 receives data indicative of selections or other actions by a user 205 and builds up a set of user data, for example comprising or representing a user history or profile, which is stored in the hard disk storage 4, and which is used in generating personalized recommendations for the user 205.

The UX engine 12 allows for the content selection interface to be configured, which may be at least in part responsive to input from an operative, such as an operative of a content provider service, and/or at least in part automatically, or any combination thereof. The UX engine 12 allows groups of content to be created. The user content selection interface presents the content items for selection by the user 205 in the groups of content. In an example, each group of content may correspond to a different carousel in a carousel type user interface, but the present disclosure is not limited to this. In some examples, at least one or each group of content may represent a different theme, such as war movies, romances, action movies, nature programs, news and current affairs, and the like. However, this need not be the case, and at least one or each group could be simply selected by the operative or another party. The UX engine 12 also allows the way in which the groups of content are provided or displayed to the user 205 to be customized to that individual user 205 or group of users 205. For example, the UX engine 12 allows customization, e.g. automated customization, of the order in which groups of content are provided to the user in the user content selection interface, which may be an order in which the carousels corresponding to different groups are provided in the content selection interface. In some examples, this comprises allowing selected groups of content to be fixed in a set place in an ordering of the groups of content. In examples, this comprises allowing the UX engine 12 to determine a customized ordering of at least some or all of the groups of content for each user 205 or group of users 205, which may be based at least in part on groups of content that the user 205 or group of users 205 have previously interacted with in some way, e.g. whilst using a user content selection interface.

The ordering of the groups of content (and content recommendations in examples in which the UX engine 12 is part of a recommendation system 2) can be based on user actions, wherein at least some of those user actions include user interaction with content recommendation user interfaces. FIG. 1 shows user actions and requests for recommendations or ordering of content being communicated directly to the recommendation system 2 from the user devices 40. In addition to receiving requests for recommendations of content or ordering of groups of content, the recommendation system 2 is configured to log user activity. By logging user activity and storing activity over an extended period of time, the recommendation system 2 and the hard disk storage 4 can build up an overall picture of the actions of a plurality of users relating to their interactions with content selection interfaces. User actions are turned into learn actions by the user learning module 24 to be processed by the user profile module 26, the UX engine 12 and the content recommendation engine 22.

The system of FIG. 1 is configured to operate with a plurality of user devices 40 each associated with at least one user 205 (e.g. belonging to the user 205 or into which the user 205 is logged in). The plurality of user devices 40 may comprise a large number of devices 40, for example thousands, tens or hundreds of thousands, or even millions of devices 40. Each user device 40 may be any device or combination of devices that is configured to enable a user to view or otherwise consume content. For example, each user device 40 may be an internet-enabled device and/or a device for providing video or other content on demand and/or a device capable of receiving a real-time linear television broadcast signal. The user device 40 may be a mobile device, for example a tablet, a smart phone or a laptop. Alternatively, the user device 40 may not be mobile, for example, an internet browser enabled computing device, a smart television or a set-top box. The user device 40 may also have an in-built or associated PVR for recording and storing content in some embodiments.

The user 205 may be a viewer of the user device 40. Alternatively or additionally, the user 205 may be a subscriber and/or customer of a service accessible through the user device 40.

The user cache 6 is coupled to the user profile module 26, the UX engine 12 and the content recommendations engine (CRE) 22, and data stored by the user cache 6 may be used by the user profile module 26, the UX engine 12 and the content recommendations engine 22. The recommendation system 2 can access data stored on the user cache 6. The user cache 6 may be provided in random access memory (RAM) 7.

The hard disk storage 4 is communicatively coupled to the recommendation system 2. The hard disk storage 4 stores data for use by the recommendation system 2, including user actions, also referred to as user activity. The hard disk storage 4 is configured to store one or more databases. Entries from the databases on the hard disk storage resource 4 can be retrieved by requests made through a data access layer. Entries in the databases may also be updated via the data access layer.

The database(s) at the hard disk storage 4 store user data that is used by the user profile module 26 to generate and update user profiles for users 205. That data can be used by the content recommendation engine (CRE) 22 to generate recommendations for configuring the content selection interface for the specific user 205 and/or can be used by the UX engine 12 to order groups of content for presentation on the content selection interface. In the embodiment of FIG. 1 a set of database tables is provided that store information concerning the users 205.

In the embodiment of FIG. 1, the tables may include at least one user service table 36 that represents user service requirements, and at least one user profile table 30 that includes user attribute data that may be included in a user profile. A user profile may include, for example, the following attributes: unique identifiers, for example a user identifier, a subscriber identifier, an anonymous session identifier; one or more unique geographic identifiers; a flag indicating whether or not the user has a PVR; a flag indicating whether or not the user is in debt; a flag indicating whether or not the user has opted out of receiving marketing material; one or more codes indicating one or more preferred languages of the user; a flag indicating if the user has opted out of receiving personal recommendations; the age of the user; the name of the user, the gender of the user and/or the like.

In the embodiment of FIG. 1, the tables may include various user learning tables that include data representing user 205 actions, also referred to as user activity, relating to content selection interfaces. Examples of user 205 actions that constitute user activity that can be collected include one or more or each of: selecting content from a group of content or a related group of content; scrolling through content in a group of content or a related group of content; hovering a cursor for greater than a threshold period over a group of content or a related group of content; pausing scrolling for greater than a threshold period through groups of content whilst a group of content or a related group of content is displayed on a user interface; downloading content that is in a group of content or related group of content; having watched at least part of content that is in a group of content or related group of content; bookmarking content that is in a group of content or related group of content; browsing content that is in a group of content or related group of content; recording content that is in a group of content or related group of content; adding content that is in a group of content or related group of content to virtual shopping basket or otherwise selecting for purchase or potential purchase; watching or listening to a trailer for content that is in a group of content or related group of content; playing content that is in a group of content or related group of content on a user device; purchasing content that is in a group of content or related group of content; clicking on or otherwise selecting content that is in a group of content or related group of content from a list of search results; remotely recording content that is in a group of content or related group of content; setting a reminder for content that is in a group of content or related group of content; liking, making a favorite or otherwise adding to a list content that is in a group of content or related group of content; disliking content that is in a group of content or related group of content; messaging about content that is in a group of content or related group of content; posting on social media about content that is in a group of content or related group of content; playing purchased content that is in a group of content or related group of content; stopping watching or playing content that is in a group of content or related group of content; and/or rating content that is in a group of content or related group of content, from amongst others.

For example, if a user 205 selects a program or other item of content from a content selection interface and views or otherwise consumes it for greater than a threshold period of time then a learn action is generated and at least one user data item for that user is stored in at least one of the tables. The data item may include various data including for example start and stop viewing time, time slot identifier, program identifier, which group of content the content belongs, at least some metadata concerning the program (although such metadata may be stored separately as content data rather than user data in some embodiments, and linked to or otherwise accessed if required, for example by the program name or other identifier). The user learning module 24 determines whether user data should be stored in the tables in respect of a particular user action or set of actions. For example, if a user only views a program for a very short period of time, for instance if they are channel surfing, then user data is optionally not stored in the user learning tables in respect of that action. User data can be stored in respect of a variety of different user actions or events, for example selecting, viewing, recording or searching for content or any of those listed above or others that would be apparent to a skilled person.

In the embodiment of FIG. 1 a large part of the user data comprises user history or user action data that represent user actions over a significant period of time. In various embodiments, there is a limit to how long user data is kept or used. For example in the embodiment of FIG. 1 after a threshold period, for example six months after being collected, items of user data are deleted. Thus, in some embodiments the user data for a particular user 205 may include only relatively recent user action data, although the amounts of data may still be substantial.

Although a particular system arrangement is shown in FIG. 1, there are various system arrangements that could be used.

FIG. 2 shows a “middleware” arrangement in which the recommendation system 2 sits as “middleware” between the users 205 and systems of a content provider 210. The recommendation system 2 is implemented by processing resource 220 (which may comprise one or more processors) with the storage device 4 and user cache 6. In some examples, the recommendation system 2 can be implemented by a cloud computing system, by one or more servers or other suitable enterprise level computing system. In this arrangement, systems that implement the recommendation system 2 receive data sent from the user devices 40 of the users 205 that represents the user actions/user activity taken by the user 205 that are relevant to the content selection interface, such as but not limited to actions taken by the user 205 during operation of the content selection interface, including one or more of the user actions listed above. The user devices 40 also provide a user ID that can be used to identify the user 205 to allow the provision of a content selection interface that is customized for that user 205. The user devices 40 communicate the data over a network, such as the cloud 215, to the recommendation system 2. The recommendation system 2 records the user actions in order to generate learn actions and build and update a user profile that can be used to configure and customize a content selection interface for the user 205. The recommendation system 2 can communicate the requests and other data from the user devices 40 to the content providers systems 210 in order to provide the content to the user devices 40.

Other system arrangements that provide similar functionality to customize the content selection interfaces for users are possible. FIG. 3 shows an alternative system configuration in a “backend” processing arrangement. In this arrangement, the user devices 40 interface directly with the systems of a content provider 210, which implements the content selection interface and handles the requests from the user devices 40. User interaction data from the user devices 40 is provided by the systems of a content provider 210 to the recommendation system 2 in order for the recommendation system 2 to identify learn actions and build user profiles for at least partly customizing the content selection interface for that user. The recommendation system 2 provides the data for customizing the content selection interface for that user, including an ordering with which to present at least some of the groups of content in the user selection interface, to the systems of a content provider 210 for providing in the content selection interface for that user 205.

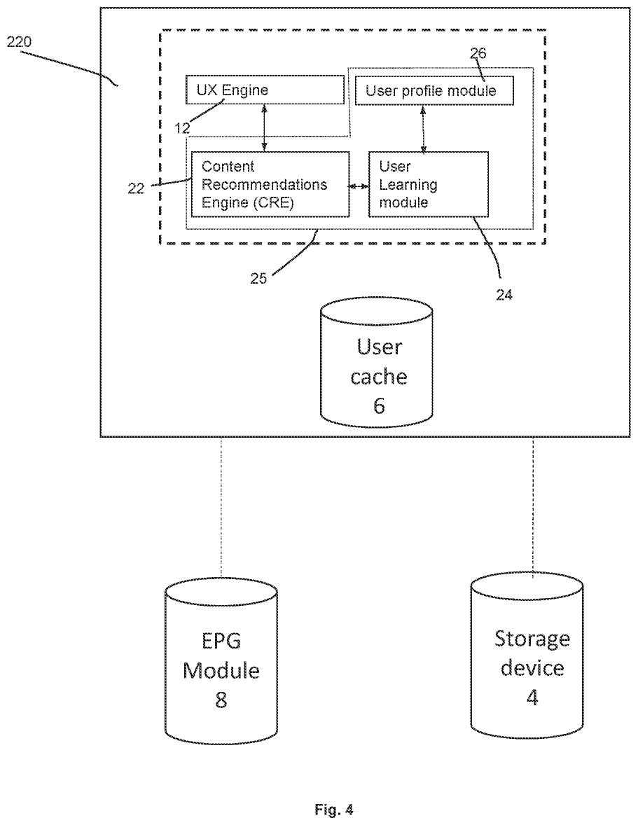

FIG. 4 shows an arrangement of processing resource 220 for implementing the recommendation system 2, including the UX engine 12 and in some examples also the recommendation service 25 that includes the CRE 22, the user learning module 24 and the user profile module 26. The processing resource can optionally comprise one or more processors, FPGAs, ASICS or the like, which may be provided in a single machine or distributed over a plurality of machines, and may be locally arranged or remote from each other and connected over a network. The processing resource 220 is configured to communicate with content databases, such as the EPG module 8, to retrieve content available from the content provider. The processing resource 220 comprises rapid access storage, such as user cache 6, which may be implemented in RAM or SSD storage to provide fast access to user profiles and actions that the processing resource is currently, and will next be, performing operations on. The processing resource is also configured to communicate with external storage such as storage device 4 on which user actions and profiles are stored and can be retrieved into the use cache 6 when needed by the processing resource 220. The UX engine 12 can be accessed by the operatives of the content provider (or other suitable users) to configure the user content selection interface provided to user devices 40 for navigating and accessing the content available from the content provider. As part of this, the UX engine 12 can identify groups of content for presentation to the user 205 and order the groups based on the user actions collected for that user 205 for providing a suitably customized content selection interface to the user 205 on their user device 40, as will be described in more detail below.

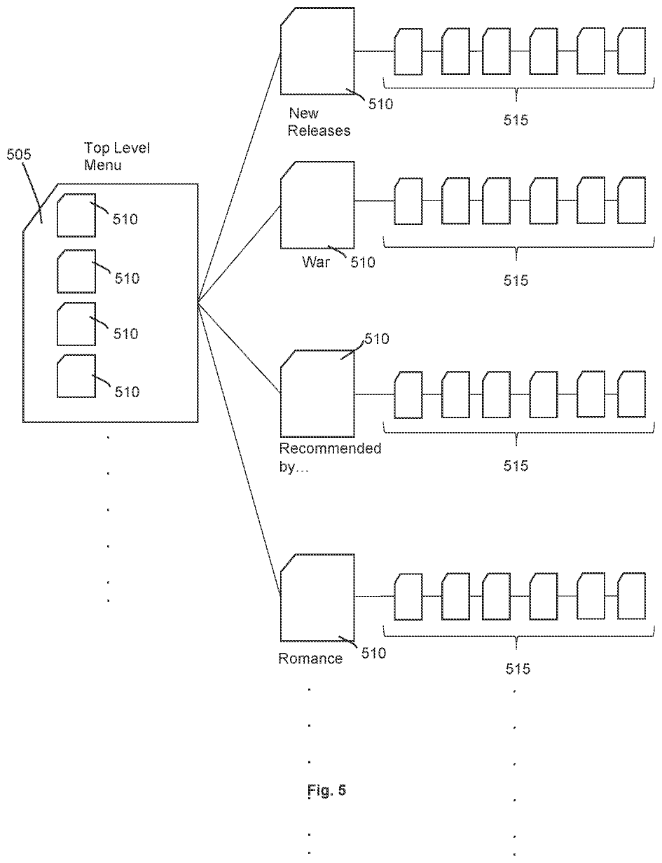

FIG. 5 shows a file structure for storing the groups of content. A high level folder 505 can contain all or at least a plurality of the groups of content 510 available for a given content provider or a different service of a content provider 210. The service provider may have one or multiple high level folders (e.g. corresponding to different services, subscriptions, seasons or the like or simply may contain different groups of content that are in some way related or grouped together for ease of organization or administration). The dots in the Figure indicate the possibility of one or more additional similar features. Each high level folder 505 may apply common settings to the groups of content 510 within that folder 505. For example, a flag for a high level folder 505 can be set to “fixed”, which would mean that the positions of all groups of content 510 in that folder 505 in an ordering of groups of content 510 for display on the content selection interface would be fixed or a flag for a high level folder 505 can be set to “customizable”, which would mean that the positions of all groups of content 510 in that folder 505 in an ordering of groups of content 510 for display on the content selection interface would be dynamically customized for that user 205 or group of users 205 based at least in part on a number of user actions recorder for that user in relation to the relevant group of content 510. In some examples, the high level folder may be a top level or root folder but could be any folder that would be useful to organize the groups of content. This arrangement may allow operatives to more quickly configure content selection interfaces by allowing settings to be quickly applied to multiple groups of content 510 by arranging them into folders 505.

Each high level folder 505 comprises a plurality of groups of content 510. As noted above, each group of content 510 may simply comprise a plurality of content items 515 selected by an operative or may comprise content items 515 that correspond to a common theme associated with the group, such as “new releases”, “war”, “recommended by . . . <<recommender>>”, “recently added”, “previously viewed”, “romance”, “like”, “suitable for age <<age of user>>”, “recommended “favorites”, “because you watched . . . <<related content>>”, and/or the like. The UX engine 12 can tailor the order in which at least some of the groups of content 510 are provided to the user 205 in the content selection interface, based at least in part on user actions, e.g. number of user actions, relevant to particular groups of content 510 made during their use of the content selection interface. Importantly, whilst the content recommendation engine (CRE) 22 is configured to recommend content items 515 that may be of interest to the user 205 (e.g. which can be used to generate the groups of content 510 that may be of interest to the user 205, for example by selecting content items 515 for each group 510), the UX engine 12 is operable to optimize the order that the groups 510 are presented to a user on a content selection interface. Thus, the CRE 22 has a purpose distinct from that of the UX 12.

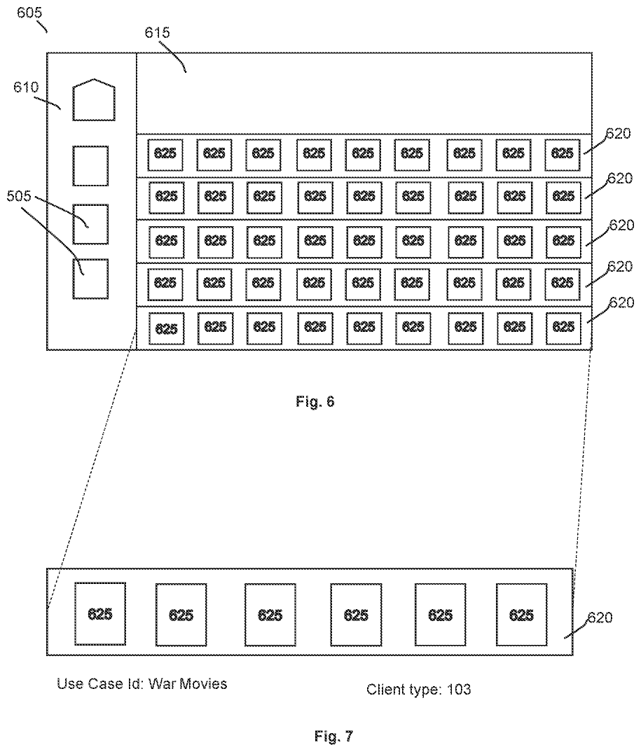

FIG. 6 shows an example of a content selection interface 605. In this example, the content selection interface 605 optionally comprises a high level menu bar 610 down one side that can contain functions such as “home page”, “search” and/or may show the high level folders 505 that are available for selection. In some examples, the high level menu bar 610 can be used to switch content provision services or users or switch high level folders 505, which may impact the groups of content provided by the content selection interface 605. That is, the groups of content 510 displayed and available for content selection will automatically update on selection of a service, user or high level folder 505 in the high level menu bar 610 to show groups of content 510 associated with that service, user and/or high level folder 505.

The content selection interface 605 further comprises a headline banner 615 that is optionally always fixed at the top of the content selection interface 605 or at least is provided as the first selectable item in the content selection interface 605 at least until such time as an operative may change the headline banner 615.

Beneath the headline banner 615 is a plurality of carousels 620, each carousel 620 containing a respective group of content 510. In this example, each carousel 620 comprises a plurality of selectable content indications 625, each content indication representing a different contain item 515 that is contained in the group of content 510 represented by that carousel 520. Thus, in the content selection user interface, each carousel 620 corresponds to and shows a corresponding different group of content 510, and each content indication 625 represents and indicates a different item of content 515 from the group of content 510 that can be selected by the user 205 by selecting the corresponding content indication 625.

The user 205 can scroll up and down through the carousels 620, with new carousels 620 representing different groups of content 510 appearing at the bottom and the top carousel 620 disappearing at the top as the user scrolls down through the carousels 620 and vice versa as the user 205 scrolls up through the carousels 620. When the user 205 identifies a carousel 620 corresponding to a group of content 510 of interest, the user 205 can scroll from side to side along the carousel 620 to scroll through the selectable content indications 615 representing the items of content 515 in the group of content 510 associated with that carousel 620. A detail view of a carousel 620 representing a group of content 510 from the content selection interface 605 is shown in FIG. 7, which shows a plurality of selectable content indications 625, each representing a different user selectable content item 515. The content indications 625 may comprise a thumbnail showing an image of the item of content 515 and/or text indicating the name of the content 515 or the like. When the user identifies the content 515 represented by the content indication 625 that they want to consume, then the user 205 selects the desired content indication 625 from that carousel 620 to request provision (e.g. download, streaming or viewing) of the item of content 515 represented by that content indication 625. Of course, there are many arrangements of content selection interfaces and the present disclosure is not limited to the particular arrangement of content selection interface 605 shown in FIGS. 6 and 7. For example, in alternative content selection interfaces, the user 205 can scroll through groups of content 510/carousels 620 horizontally (or in any other direction) and scroll through the content indications 625 representing content items 515 vertically (or in another direction that is different from the direction through which the groups of content are scrolled through). Some content selection interfaces may be arranged in a hierarchical structure, with the user able to drill down through groups of groups of content 510, into groups of content 510 and finally down into content items 515. However, various other arrangements would be apparent to a person skilled in the art and to which the concepts of the present disclosure could be applied and the present disclosure is not limited to the content selection interface 605 shown in FIGS. 6 and 7.

The content items 515 in the groups 510 or the groups 510 themselves can optionally be picked by an operative or selected by the content recommendation engine (CRE) 22 for that user. The ordering of at least some of the groups of content 510 in the content selection interface 605 is customized/specifically determined for that user 205 based at least in part on previous user actions relating to, e.g. during use of, the content selection interface 605 (or other content selection interfaces 605).

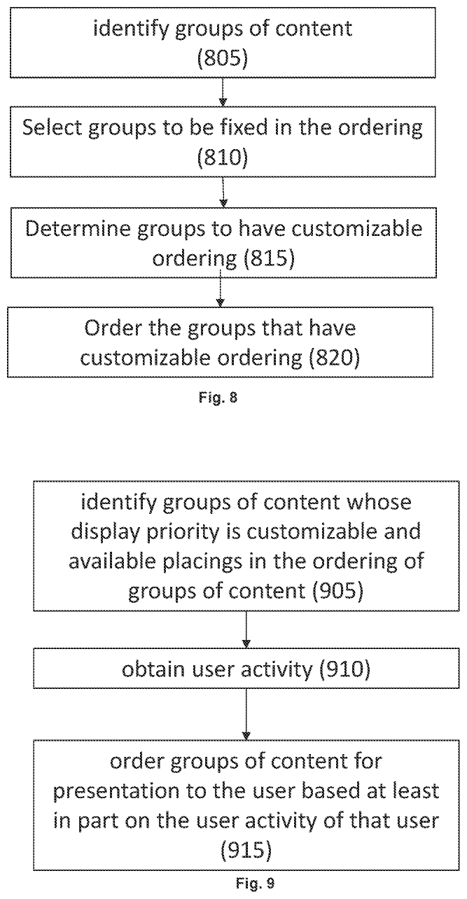

FIGS. 8 and 9 give examples of methods of operation of the UX engine 12 to configure and provide the content selection interface 605.

The UX engine 12 provides a composer facility that can be accessed by operatives of the content provider 210 to configure content selection interfaces 605 displayed on the user devices 40. The composer facility provided by the UX engine 12 allows the operatives of the content provider 210 to configure the groups of content 510 displayed on the content selection interfaces 605, such as selecting which groups of content 510 can be displayed, selecting the content 515 that belongs to each group of content 510, specifying which groups of content 510 are fixed in the ordering of groups of content (and at which position in the ordering) and which groups of content 510 are dynamically and/or customizably positionable in the ordering of groups of content 510 displayed on the content selection user interface 605 for a specific user 205 or group of users 205, amongst other potential configurable controls on the user selection interface 605. For example, the composer facility provided by the UX engine 12 can be accessed by operatives using a composer facility user interface accessible over a network (e.g. the cloud) in order to configure the groups of content 510 and/or the way the UX engine 12 operates to provide the groups of content 510 in the content selection interface 605 on user devices 40.

The recommendation system 2 communicates with the systems of a content provider 210 over a network. The recommendation system 2 can communicate the data from the user devices 40 to the systems of a content provider 210 and any data necessary for the system of the content provider 210 to access the composer facility provided by the UX engine 12. The systems of the content provider 210 can provide lists of the items of content 515 available from the content provider and any associated metadata, user IDs and any associated user metadata, selections from the operatives of the content provider 210 and the like over the network to the recommendation system 2.

In step 805, the groups of content 510 can be identified. This may comprise retrieving prep-prepared groups of content 510 that are stored in a database. Alternatively or additionally, it may comprise creating one or more of the groups of content 510 using the composer facility provided by the UX engine 12. For example, the content 515 that forms at least one or each group of content could simply be manually selected by an operative of the content provider or another user. Additionally or alternatively, the content 515 that forms at least one or each group of content could be content 515 that is recommended by the content recommendation engine (CRE) 22 for the particular user 205 or group of users 205. This recommended content 515 could be used to automatically create or populate groups of content 510 or may be provided on the user interface of the composer facility of the UX engine 12 to allow the operative or other user to manually create groups of content 510 from the content recommended by the CRE 22. Additionally or alternatively, the content may be automatically or manually arranged into groups of content 510 having a common theme. For example, each item of content 515 may be associated with metadata indicating one or more themes associated with the content, or the themes associated with each item of content may be retrievable from a database or other data source in order to categorize the content into groups of content 510. Examples of themes could include chronological themes such as “recently added”, “music from the 80s”, and the like. Other examples of themes include genres such as “action movies”, “political thriller”, “sci-fi”, “super-hero”, “romance”, “fantasy” “comedy” and the like. Another example is content suitable or recommended for an age or demographic of the user, such as “content recommended or suitable for age <<age or range of ages corresponding to age of user>>”. Further examples of themes include “selected by . . . <<different selectors>>”, “liked by . . . <<different people>>”, and so on. However, the present disclosure is not limited to these and many other ways of grouping content could be envisaged by a skilled person from the present disclosure.

In some examples, at step 810, the UX engine 12 is configured to allow the fixing of certain groups of content 510 in the order for presentation on the content selection interface 605. The fixing of certain groups of content 510 can be set in the user interface of the composer facility of the UX engine 12. For example, if the operative of the content provider 210 wishes to highlight or de-highlight a particular group of content 510, then they can fix the position of that group of content 510 in the ordering that the groups of content 510 are presented to the user 205 in the content selection interface 605. For example, a group of content 510 “romance” can be fixed to be displayed first in the ordering of groups of content 510 around Valentine's Day and will always be presented first of the groups of content 510/carousels 620 in the content selection interface, regardless of what ordering is determined for the other groups of content 510. In another example, the content provider 210 may wish to promote a latest big-budget series “Blockbuster” and as such may fix the location of a group of content 510 that comprises content 515 in the form of episodes of the show “Blockbuster” in a prominent position in the ordering of groups of content 510, e.g. so that it is always displayed first or second in the content selection interface 605 on the user devices 40 (at least until the display setting for the “Blockbuster” group of content 510 is changed by the operative).

In step 815, the UX engine 12 is configured to allow the ordering of at least some of the groups of content 510 for presentation on the content selection interface 605 to be dynamically customized for the particular user 205 or groups of users 205 or at least their user device 40. Those groups of content 510 whose ordering when presented on the content selection interface 605 can be customized can be selected by the operative using the user interface of the composer facility of the UX engine 12 or can be set by default for any groups of content 510 whose positions haven't been fixed in step 810. That is, any groups of content 510 and placing in the ordering of groups of content 510 that are not fixed are by default customizable. In a further example, groups of content 510 and placings in the ordering of groups of content 510 that are customizable can be automatically selected according to one or more rules or algorithms.

In step 820, those groups of content 510 whose placings in the ordering of groups of content 510 are customizable are customized for that user 205 by being ranked in an order based at least in part on pervious interactions by that user 205 with the content selection interface 605 (and optionally with other similar content selection interfaces) and displayed to the user 205 in the content selection interface 605 for that user 205 in that customized order. The process of ordering the groups of content 510 that are customizable is described in more detail with reference to FIG. 9 below.

In step 905 of FIG. 9, the groups of content 510 whose placing in the ordering of groups of content 510 in the content selection interface 605 is customizable and those places in the ordering of groups of content 510 that are not already taken by fixed groups of content 510 are determined.

In step 910, the user actions for the user 205 or group of users 205 for whom the content selection interface 605 is being customized are obtained, e.g. retrieved from storage device 4. The user actions relevant to a particular group of content 510 include user actions during previous operation of a content selection interface 605 by that user 205 that are relevant to that group of content 510. Examples of suitable user actions that are relevant for a particular group of content 510 include, by way of example, at least one or any of: selecting content from that group of content or a related group of content; scrolling through content in that group of content or a related group of content; hovering a cursor for greater than a threshold period over that group of content or a related group of content; pausing scrolling for greater than a threshold period through groups of content whilst that group of content or a related group of content is displayed on a user interface; downloading content that is in that group of content or related group of content; watching at least part of content that is in that group of content or related group of content; bookmarking content that is in that group of content or related group of content; browsing content that is in that group of content or related group of content; recording content that is in that group of content or related group of content; adding content that is in that group of content or related group of content to virtual shopping basket or otherwise selecting for purchase or potential purchase; watching or listening to a trailer for content that is in that group of content or related group of content; playing content that is in that group of content or related group of content on a user device; purchasing content that is in that group of content or related group of content; clicking on or otherwise selecting content that is in that group of content or related group of content from a list of search results; remotely recording content that is in that group of content or related group of content; setting a reminder for content that is in that group of content or related group of content; liking, making a favorite or otherwise adding to a list content that is in that group of content or related group of content; disliking content that is in that group of content or related group of content; messaging about content that is in that group of content or related group of content; posting on social media about content that is in that group of content or related group of content; playing purchased content that is in that group of content or related group of content; stopping watching or playing content that is in that group of content or related group of content; rating content that is in that group of content or related group of content; and/or the like.

In step 915, the customizable groups of content 510 are ranked in order depending at least in part on the number of user actions when previously using a content selection interface that are relevant to the group of content 510 or to another group of content that is related to the group of content 510. A related group of content may be, for example, a group of content having at least one content item in common, a group having a common or similar theme or genre, or the like. Those groups of content 510 having more user actions relevant to that group are ranked higher in the ordering of groups of content than groups of content 510 having less user actions that are relevant to them. In other words, of the customizable groups of content 510, groups of content with more previous user actions whilst using a content selection interface that are relevant to them are ranked higher and displayed higher up the order than, or in preference to, those customizable groups of content that have fewer previous user actions that are relevant to them.

In some examples, the ordering of the groups of content 510 for presentation to the user on the content selection interface can comprise ordering or ranking the groups of content 510 using a machine learning module based at least in part on the user activity. In this case, the UX engine 12 comprises or has access to a machine learning module. For example, the machine learning module may implement at least one machine learning model that has been trained on training data or otherwise configured to transform inputs that include at least the user activity relevant to each group of content 510 and optionally also context or other data, and to output an ordering of groups of content 510, e.g. to reflect a preference of the user. That is, in some examples, the machine learning model may be configured to output the expected preferred order for the user based on the user activity. The user activity input into the machine learning model may be provided with indications of the groups of content, and optionally also the users, to which it is relevant. In examples, the machine learning model may have been trained on training data that comprises known user actions for a user (and optionally known context or other data) and a score or scores from the user that the user actions relate to, the score indicating how relevant the ordering is for that user. In examples, the machine learning model is updated or trained based on user feedback. For example, the user may be invited to give a score for how well the provided ordering of groups of content 510 meets their requirements and the score from the user may be used, in addition to the user actions and optionally also the context or other data that gave rise to that ordering, as further training data to update the machine learning model. The machine learning model is optionally specific for a given user. The feedback learning may result in a machine learning model that better reflects the user and gives better ordering of the groups of content for that user. Furthermore, due to the feedback learning, the system may continuously improve and better adapt to changes in preferences of the user.

In some examples, other data could be used to modify the ordering. For example, context data could be used to modify the ordering that the customizable groups of content 510 are presented in the content selection interface 605. The context data can be obtained from other data sources 14, for example. For example, a ranking score for determining the order in which the customizable groups of content 510 are presented in the content selection interface 605 can be determined. The ranking score for a group of content 510 depends on both the number of previous user action relevant to that group of content 510 and the context or other data. For example, the context data may comprise weather data and when the context data indicates sunny weather then groups of content 510 having themes associated with sunny weather such as “feel good movies” or “comedies” may have their ranking score increased. In another example, the context data may indicate current affairs or trending topics and groups of content with a theme relevant to topics in the current affairs or trending topics may have their ranking scores increased. In general, a mapping or set of rules or conditions may be provided that specifies how the ranking score for which groups of content 510 may be adjusted in what way depending on each value for the context or other data. In this way, context data can be provided to bias the ordering in which the groups of content 510 are displayed in the content selection interface 605 to take into account transient or variable effects, such as the weather, currently trending topics, and so on. This may result in a more suitable ordering of the groups of content 510 for that user 205. The context or other data can also be provided as inputs to the machine learning data in addition to the user actions relevant to respective groups of content 510.

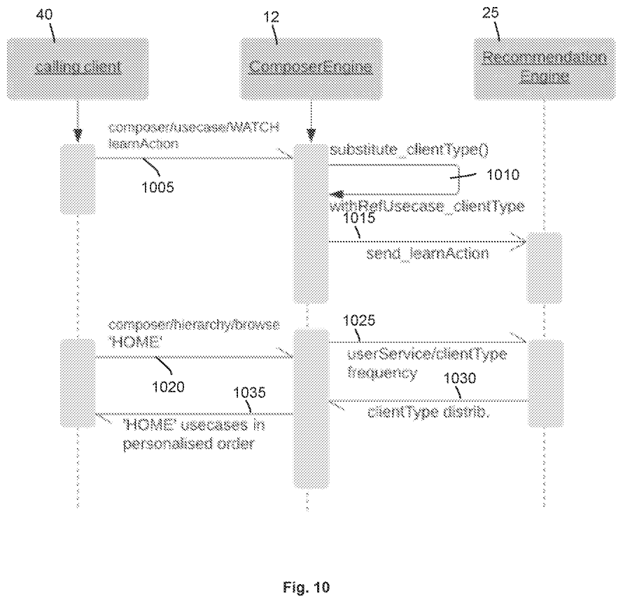

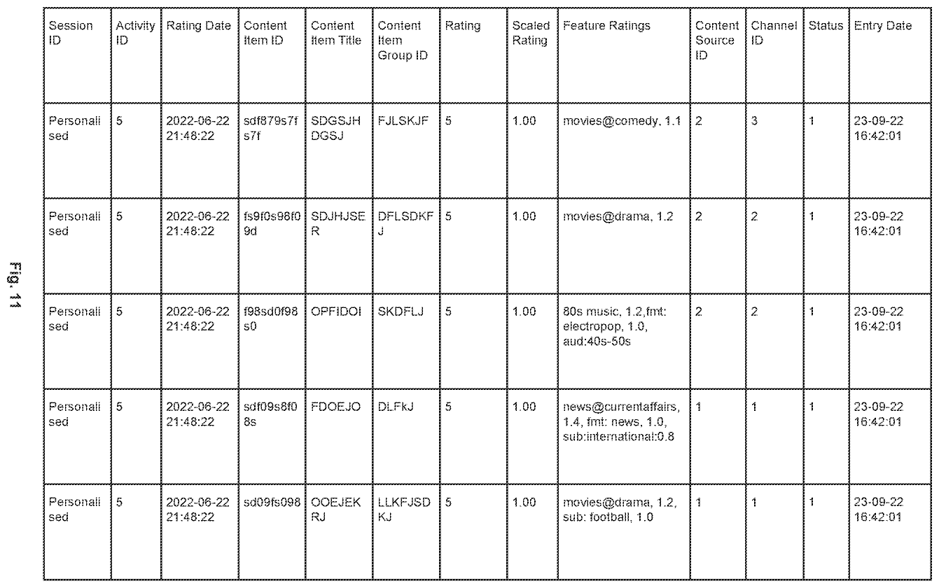

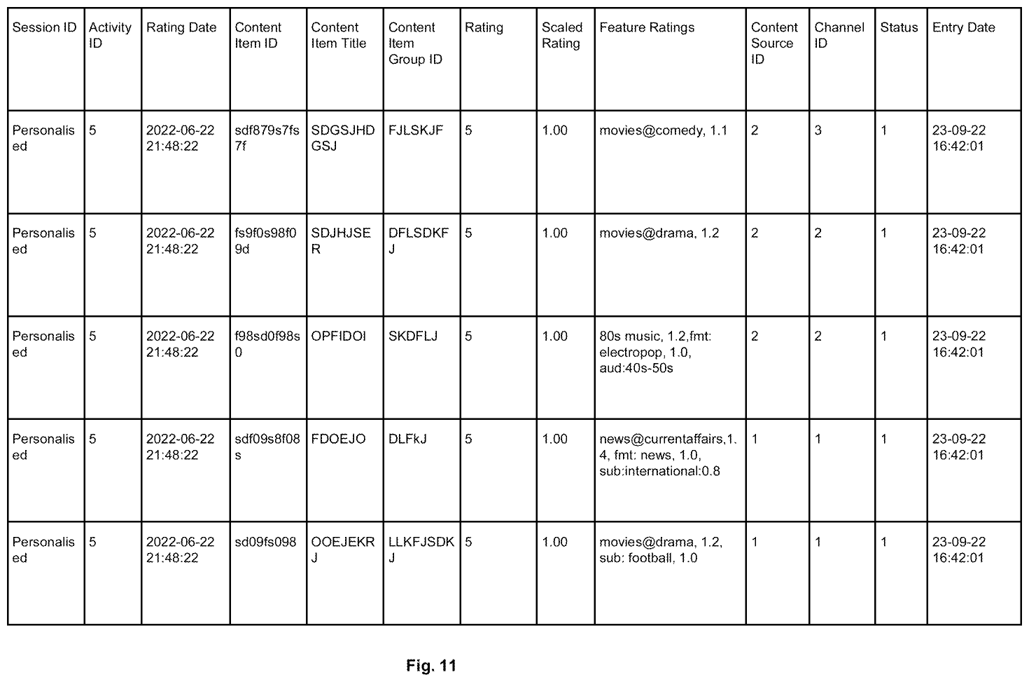

FIG. 10 illustrates the interactions between user devices 40, the UX engine 12 and a recommendation service 25 (see FIGS. 1 to 3) of the recommendation system 2, which comprises at least the user learning module 24 and user profile module 26. When the user 205 interacts with a content selection interface 605 on their user device 40 (i.e. performs a user action), the user device 40 sends 1005 (directly or indirectly) a notification and associated data to the recommendation system 2. The associated data includes at least a user 205 or user device 40 ID, data identifying the action and identifying the content 515 or group of content 510 to which the action related. User actions with the content selection interface 605 are provided to the UX engine 12. The UX engine 12 is configured to identify the content 515 that the user has interacted with and identifies the group or groups of content 510 to which the content 515 belongs and adds this to the metadata in 1010. A learn action linking the user action to the group of content 510 is then sent in step 1015 to the recommendation service 25 for storing in the data storage 4 and for updating the user profile 30. An example of a list of learn actions that reflect user 205 interactions with a content selection interface 605 on their user devices 40 is shown in FIG. 11, which can be stored on the data storage 4 for later use by the UX engine 12. Steps 1005 to 1015 reflect a learning process that comprises the building up of learn actions reflecting the user interaction with content selection interfaces 605 on their user devices 40 that are subsequently used by the UX engine 12 to order the groups of content 510 for display on the content selection interface 605, at least in part by determining a number of the user actions that are relevant to each group of content 510 and ordering the groups of content 510 for display on the content selection interface based on that number.

When the user 205 wants to consume content, the user 205 opens the content selection interface 605 for the content provided 210 on their user device 40. The user device 40 sends a corresponding request in step 1020 to the UX engine 12, including the user or device ID or user type. The UX engine 12 identifies which groups of content 510 are available for that user 205 and content provider 210 and sends that data and the user or device ID as a request to the recommendation service 25 in step 1025. The recommendation service 25 can determine the number of previous user actions by that user 205 whilst using the content selection interface 605 (or other content selection interfaces) that are relevant each of the groups of content 510 (and optionally with other groups of content associated with each of the groups of content 510, and in some examples also the context data for each group of content 510. The number of previous interactions by that user 205 with each of the groups of content 510 and the context data, if applicable, is returned to the UX engine 12 in step 1030, which uses it to rank the groups of content 510 into order for presentation on the content selection interface 605. Specifically, the UX engine 12 is configured to rank the groups of content 510 into order for presentation on the content selection interface so that the groups with a higher number of previous user interactions (as modified by the context data if applicable) are presented in preference to, or ahead of, those having a lower number of user interactions (as modified by the context data if applicable). In step 1035, the groups of content 510 are returned with the order for presentation indicated by the UX engine 12 to the mobile device 40 so that the mobile device can provide a customized version of the content selection interface with the groups of content 510 presented in an order tailored to that user 205.

The system described herein can be used to provide content selection interfaces that may in some examples allow a user to more quickly identify content of interest and to better navigate content available from a content provider system. As groups of content more likely to be of interest may be displayed in preference to, or earlier than, groups of content that are less likely to be of interest, then the user can more quickly identify content of interest without reducing the size of carousels, without excessive scrolling and making better use of limited screen estate to display the content selection interface 605.

Although various specific examples have been described above, these are provided to help understanding of the present disclosure and other possible implementations can be used. For example, although specific arrangements of systems and networks that could be used to implement the concepts disclosed herein are shown in FIGS. 1 to 3, other systems architectures could be used. For example, the UX engine 12 could be provided as a stand-alone system rather than being integrated with the content recommendation engine 22 or integrated into a content provider system rather than being provided as a separate intermediate or backend system.

Method steps described herein can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customized circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented with a user device 40 having a screen, e.g., a CRT (cathode ray tube), plasma, LED (light emitting diode) or LCD (liquid crystal display) monitor, for displaying information (e.g. the content selection interface 605) to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

As such, the above description of specific embodiments is made by way of example only. A skilled person will appreciate that variations of the described embodiments may be made without departing from the scope of the invention.

What is claimed is:

1. A computer-implemented method of configuring a content selection interface, the method comprising:
identifying groups of content;
obtaining user activity, wherein the user activity comprises interactions by the user with groups of content on a content selection interface; and
ordering groups of content for presentation to the user on the content selection interface based at least in part on the user activity of that user.

2. The method of claim 1, wherein the user interface comprises a plurality of scrollable carousels and the method comprises providing respective groups of content to the user in respective carousels of the user interface, and the ordering of the groups of content comprises ordering the carousels in the user interface.

3. The method of claim 1, comprising monitoring user interactions with groups of content on a user interface, wherein the user interaction with groups of content on the user interface comprises one or more of:
selecting content from a group of content or a related group of content;
scrolling through content in a group of content or a related group of content;
hovering a cursor for greater than a threshold period over a group of content or a related group of content; and/or
pausing scrolling for greater than a threshold period through groups of content whilst a group of content or a related group of content is displayed on a user interface
downloading content that is in a group of content or related group of content;
having watched at least part of content that is in a group of content or related group of content;
bookmarking content that is in a group of content or related group of content;
browsing content that is in a group of content or related group of content;
recording content that is in a group of content or related group of content;
adding content that is in a group of content or related group of content to virtual shopping basket or otherwise selecting for purchase or potential purchase;
watching or listening to a trailer for content that is in a group of content or related group of content;
playing content that is in a group of content or related group of content on a user device;
purchasing content that is in a group of content or related group of content;
clicking on or otherwise selecting content that is in a group of content or related group of content from a list of search results;
remotely recording content that is in a group of content or related group of content;
setting a reminder for content that is in a group of content or related group of content;
liking, making a favourite or otherwise adding to a list content that is in a group of content or related group of content;
disliking content that is in a group of content or related group of content;
messaging about content that is in a group of content or related group of content;
posting on social media about content that is in a group of content or related group of content;
playing purchased content that is in a group of content or related group of content;
stopping watching or playing content that is in a group of content or related group of content; and/or rating content that is in a group of content or related group of content.

4. The method of claim 3, wherein the related group of content is a group of content having the same or a related theme or comprising at least one content item in common.

5. The method of claim 1, wherein the ordering of the groups of content for presentation to the user on the user interface comprises ranking the groups in order of expected preference of the user.

6. The method of claim 5, comprising applying a machine learning model to the user activity, the machine learning model being configured to output the expected preference of the user based on the user activity.

7. The method of claim 1, wherein the ordering groups of content for presentation to the user on the user interface for a user comprises ordering at least one or some groups of content for which there have been a higher number of interactions by that user for display preferentially to at least one or some other groups of content for which there have been a lower number of interactions by that user.

8. The method of claim 1, comprising at least one of:
presenting the groups of content to the user on the user interface in the determined order based at least in part on the user activity; and/or
providing an indication of the ordered groups of content on an interface for generating content selection interfaces.

9. The method of claim 1 comprising fixing a place of one or more groups of content in an ordering of groups of content in the content selection interface and placing at least one or each other of the groups of content in the content selection interface based at least in part on the user activity.

10. The method of claim 9, wherein the method is implemented as part of a content selection interface configuration tool, and comprises:
selecting, using the user interface configuration tool, the one or more groups of content whose place in the ordering of groups of content is to be fixed; and/or
selecting, using the user interface configuration tool, the at least one or each other of the groups of content that are to be placed in the ordering of groups of content based at least in part on the user activity.

11. The method of claim 10, wherein:
the groups of content are arranged or arrangeable into folders, each folder comprising a plurality of groups of content; and
the method comprises one or both of:
selecting, using the content selection interface configuration tool, folders to be fixed, wherein fixing a folder comprises fixing the places of all of the plurality of groups of content in that folder in the ordering of groups; and/or
selecting, using the user interface configuration tool, folders that are personalizable, wherein the places of all of the plurality of groups of content in a personalizable folder are to be placed in the ordering of groups of content based at least in part on the user activity.

12. The method of claim 1, wherein the user interface is a user interface of an electronic program guide, EPG, and the method is performed in conjunction with a method of providing television content or other content to each of a plurality of users using a content distribution system, wherein
a user device of each user displays the EPG that is operable by the user of the user device to select one or more items of television or other content; and
in response to the selections a content distribution system distributes the selected items of television content or other content to the user devices for viewing by the users during content viewing sessions.

13. The method of claim 2, wherein the user interface is configured to allow scrolling through different carousels, and scrolling through content within individual carousels, and the ordering of the carousels is based at least in part on the user activity.

14. The method of claim 1, wherein ordering groups of content for presentation to the user on the user interface comprises determining a personalized ordering the groups of content for presentation to that user on the content selection interface of a user device of that user based at least in part on the user activity of that user.

15. The method of claim 1, wherein the ordering of the groups of content for presentation to the user on the user interface is based on data of a content distribution system or middleware operator and does not comprise 3rd party data.

16. The method of claim 1 wherein:
at least one or each group is a group in which content in the group is related by a common theme; or
at least one or each group is a group selected by a user.

17. The method of claim 1 wherein the ordering groups of content for presentation to the user on the content selection interface based at least in part on the user activity of that user and additional context data.

18. The method of claim 1, wherein the content of the ordered groups of content are selectable by the user in the content selection interface to present the selected content.

19. A system comprising processing circuitry configured to:
monitor user activity, the user activity comprising user interactions with a content user selection interface on a user device;
identify groups of content;
order groups of content for presentation to a user on the user interface based at least in part on the user activity of that user.

20. A non-transitory computer-readable medium that comprises computer-readable instructions that are executable to configure a content selection interface, the configuration comprising:
identifying groups of content;
obtaining user activity, wherein the user activity comprises interactions by the user with groups of content on a content selection interface; and
ordering groups of content for presentation to the user on the content selection interface based at least in part on the user activity of that user.
